(19) United States
(12) Patent Application Publication
(10) Pub. No.: US 2024/0230596 A9
(43) Pub. Date: Jul. 11, 2024

(54) SYSTEM FOR MONITORING DEFECTS WITHIN AN INTEGRATED SYSTEM PACKAGE

(71) Applicant: STMICROELECTRONICS S.r.l., Agrate Brianza (IT)

(72) Inventors: Domenico GIUSTI, Caponago (IT); Marco DEL SARTO, Monza (IT); Fabio QUAGLIA, Pizzale (IT); Enri DUQI, Milan (IT)

(73) Assignee: STMICROELECTRONICS S.r.l., Agrate Brianza (IT)

(21) Appl. No.: 18/489,737

(22) Filed: Oct. 18, 2023

(30) Foreign Application Priority Data
Oct. 24, 2022 (IT) 102022000021900

(51) Int. Cl. G01N 29/04; G01N 29/24

(52) U.S. Cl. CPC G01N 29/04; G01N 29/2406; G01N 29/2437; G01N 2291/0231; G01N 2291/0289; G01N 2291/106

(57) ABSTRACT

An integrated electronic system is provided with a package formed by a support base and a coating region arranged on the support base and having at least a first system die, including semiconductor material, coupled to the support base and arranged in the coating region. The integrated electronic system also has, within the package, a monitoring system configured to determine the onset of defects within the coating region, through the emission of acoustic detection waves and the acquisition of corresponding received acoustic waves, whose characteristics are affected by, and therefore are indicative of, the aforementioned defects.

### BACKGROUND

### Technical Field

The present disclosure relates to a system for monitoring defects within integrated system packages.

### Description of the Related Art

In the miniaturized electronic field, a known trend is that of providing complex integrated systems within single packages (so-called SiP—System in Package).

Such systems generally comprise a certain number of dies of semiconductor material, integrating respective sensors (in particular MEMS—Micro-Electro-Mechanical System—sensors) or respective integrated electronic circuits (so-called ASIC—Application Specific Integrated Circuit), such dies being accommodated within a single package, in particular within a corresponding coating material (usually epoxy resin).

To date, there are no effective tools to detect the presence of defects (e.g., cracking, delamination, or some other type of defect) within a package of an integrated systems, if not observing, a-posteriori, the effects on the operativeness of the integrated systems (i.e., the associated degradation of performances or, in the worst case, failure to operate).

Failure analysis techniques have also been proposed to estimate the residual life of the integrated systems through statistical analysis; however, it is clear that these techniques are not entirely satisfactory, as they are unable, due to their probabilistic nature, to provide accurate information on the modes and actual times associated with the occurrence of damages or malfunctions.

### BRIEF SUMMARY

The present disclosure is directed to implementing an effective real-time monitoring of any degradation of the packaging or coating material within the package of an integrated system, in such a way as to increase the reliability of the same integrated system.

At least one embodiment of the present disclosure may be summarized as including A system, comprising: a package including: a support base; a coating region on the support base; at least a first system die coupled to the support base and in the coating region; and a monitoring system in the coating region, the monitoring system configured to, in operation, determine an onset of defects within the coating region through an emission of acoustic detection waves and an acquisition of corresponding received acoustic waves, the acoustic detection waves characteristics are affected by the aforementioned defects.

### BRIEF DESCRIPTION OF THE SEVERAL VIEWS OF THE DRAWINGS

For a better understanding of the present disclosure, preferred embodiments thereof are now described, purely by way of non-limiting example, with reference to the attached drawings, wherein:

FIG. 1 is a schematic section of an integrated system;

FIG. 2 is a schematic section of an integrated system provided with a monitoring system, according to an embodiment of the present disclosure;

FIG. 3 shows a circuit diagram of an electronic circuit associated with a transducer device of embodiments of monitoring systems of the present disclosure;

FIG. 4 is a schematic section of an integrated system provided with a monitoring system, according to a further embodiment of the present disclosure;

FIG. 5 shows plots of monitoring quantities, according to embodiments of monitoring systems of the present disclosure;

FIG. 6 is a schematic cross-section of a transducer device, according to embodiments of monitoring systems of the present disclosure;

FIGS. 7A and 7B are, respectively, a top view and a schematic cross-sectional view of a matrix of PMUT elements of a transducer device according to embodiments of monitoring systems of the present disclosure;

FIG. 8 is a schematic cross-section of an integrated system provided with a monitoring system, according to yet another embodiment of the present disclosure; and

FIGS. 9A-9C are schematic top views of possible implementations of an integrated system provided with a monitoring system, according to an embodiment of the present disclosure.

### DETAILED DESCRIPTION

As will be described in detail, one aspect of the present disclosure envisages integrating, within the package of an integrated system, a monitoring system, configured to determine in real time the onset of defects within the corresponding coating material, through the emission of acoustic detection waves, in particular ultrasound waves, and the acquisition and processing of corresponding received acoustic waves, whose characteristics are affected by, and therefore indicative of, the aforementioned defects.

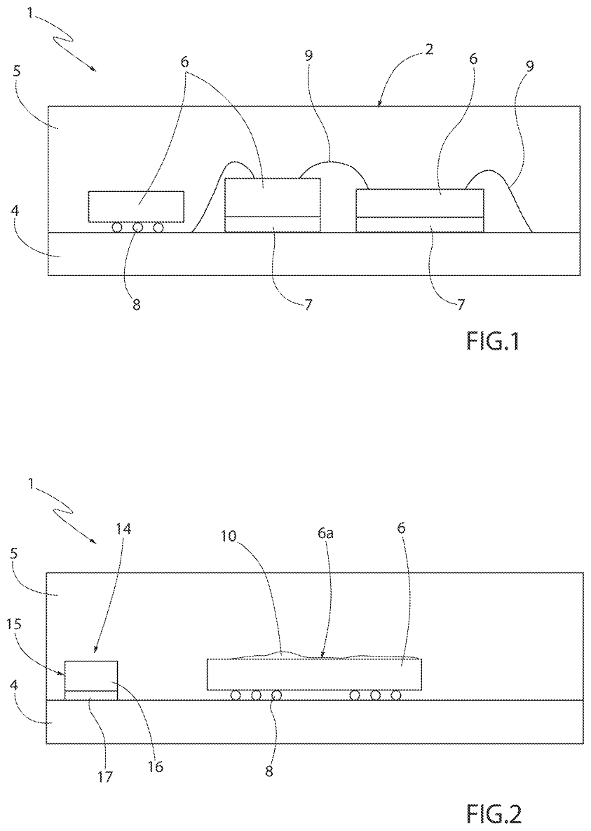

By way of example, FIG. 1 schematically shows an integrated system 1 formed in a single package 2, comprising a support substrate or base 4, for example a so-called leadframe or an organic substrate, and a coating region 5, for example of epoxy resin, formed above the support base 4.

A certain number of dies 6 (hereinafter referred to as “system dies,” three of which are depicted by way of example) are coupled to the support base 4, for example by a respective adhesive material region 7 (so-called “die attach”) or by interposing connection elements 8, for example in the form of conductive pads or balls. The system dies 6 are for example arranged side by side and are housed within the coating region 5, which coats them entirely.

Electric wires 9 connect respective system dies 6 to each other (with the so-called “wire bonding” technique) and also the same system dies 6 with contact pads and/or electrical connection tracks (not illustrated) formed on the surface of the support base 4.

As it is known, in these integrated systems 1, in particular within the corresponding packages 2, damages or breakdowns (so-called “failure” phenomena) may occur, which may entail the decay of the electrical performances or, in the worst case, a malfunction of the same integrated systems 1.

For example, breakdowns or formation of cracks may occur in the coating region 5; another common degradation phenomenon is represented by the so-called delaminations, which may occur in an “embedded” manner within the package 2 and are represented by total or partial detachments between a corresponding top and/or bottom surface of the system dies 6 and the coating region 5 (in general, such delaminations may occur at the interfaces between the same system dies 6 and the coating region 5).

To date, there are no effective tools to detect the presence of the aforementioned defects within the package 2 of the integrated systems 1, if not observing, a-posteriori, the effects on the operativeness of the same integrated systems 1 (i.e., the associated degradation of performances or, in the worst case, failure to operate).

Failure analysis techniques have also been proposed to estimate the residual life of the integrated systems 1 through statistical analysis; however, it is clear that these techniques are not entirely satisfactory, as they are unable, due to their probabilistic nature, to provide accurate information on the modes and actual times associated with the occurrence of damages or malfunctions.

As illustrated schematically in FIG. 2 (wherein elements similar to others already discussed in FIG. 1 are denoted with the same reference numerals and are not described again in detail), an integrated system 1 according to an aspect of the present disclosure thus comprises, within the corresponding package 2, a monitoring system 14 provided with at least one transducer device 15 configured for the emission of acoustic detection waves, in particular ultrasound waves.

In detail, this transducer device 15 is a micromechanical ultrasound transducer, so-called MUT, Micromachined Ultrasound Transducer, made using micromachining technologies of semiconductor materials in a respective die 16 (hereinafter referred to as a monitoring die), coupled to the support base 4 within the coating region 5, for example by a respective die attach region 17.

In one embodiment, this transducer device 15 is a piezoelectric-type transducer, PMUT (Piezoelectric Micromachined Ultrasound Transducer).

The transducer device 15 is biased (for example by an ASIC driving circuit, which may be integrated in the same monitoring die 16) so as to emit ultrasound waves which propagate within the coating region 5, in a manner confined thereto, up to reaching the interface between the system die 6 and the coating region 5.

The same transducer device 15 may be configured to receive and process the echo of the ultrasound waves, whose characteristics are affected by the presence of defects within the package 2, for example delaminations at the interface between the system die 6 and the coating region 5, in order to detect the presence of the same defects.

By way of example, the above FIG. 1 shows a delamination 10 at the aforementioned interface, in particular with the formation of an empty region between the top surface of the die (here indicated by 6a), or part thereof, and the overlying coating region 5. This empty region may be non-uniform above the top surface 6a of the system die 6, for example in terms of a corresponding thickness in the vertical direction (along a vertical axis orthogonal to the same top surface 6a).

In particular, these defects may determine a change in the acoustic impedance of the corresponding coating region 5 and therefore a different reflection (or transmission) pattern of the acoustic detection waves.

According to an aspect of the present disclosure, the aforementioned processing of the acoustic detection waves may be performed by an ASIC reading circuit integrated in the monitoring die 16 of the same transducer device 15.

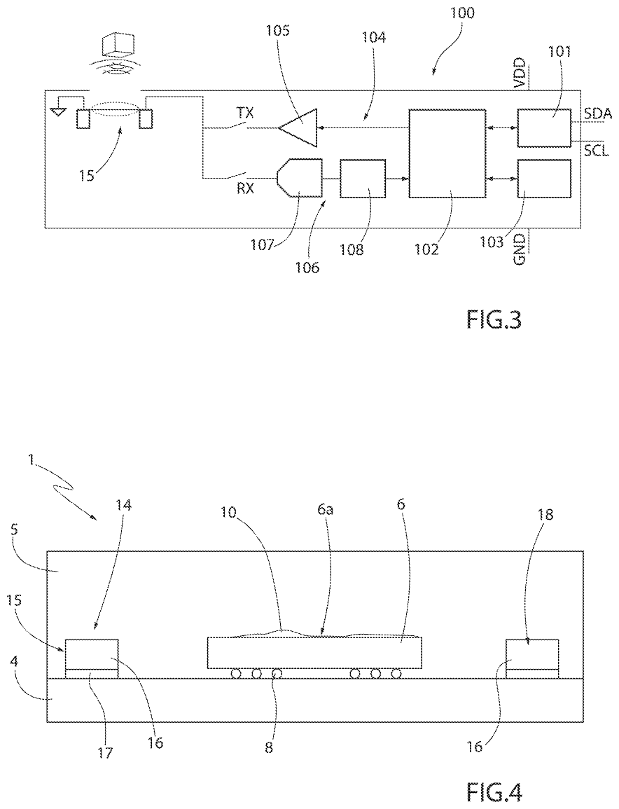

In this regard, and purely by way of example, FIG. 3 shows a possible implementation of an ASIC circuit, indicated by 100, associated with the transducer device 15 (here shown schematically) and configurable to operate alternatively as the aforementioned driving and reading circuits for the acoustic detection waves.

The ASIC circuit 100 comprises: an interface 101, configured to receive one or more configuration signals (SDA, SCL), for configuring the same ASIC circuit 100 as a driving or reading circuit; a controller 102 coupled to the interface 101 to receive the configuration signal; a non-volatile memory 103, operatively associated with the controller 102; a driving branch 104, including an amplifier 105, which may be selectively coupled to the transducer device 15 for driving the same transducer device 15; and a reading branch 106, including an ADC (Analog to Digital) converter 107 and with a DSP (Digital Signal Processor) 108, which may be selectively coupled to the transducer device 15, for reading the acoustic detection waves and providing associated reading signals to the controller 102.

In a possible embodiment, shown by way of example in FIG. 4, the aforementioned monitoring system 14 comprises at least: a first transducer device, denoted again by 15, operating as an emitter of acoustic detection waves, in particular ultrasound waves, so that they impinge on at least one system die 6, of which it is desired to monitor a corresponding interface with the coating region 5; and a second transducer device 18, operating as a receiver of the acoustic detection waves (after the same acoustic detection waves have impinged on and traversed the aforementioned interface to be monitored).

Both the aforementioned first and second transducer devices 15, 18 may be of the PMUT type, in this case being provided in respective monitoring dies 16 of semiconductor material, which may be arranged side by side, on opposite sides of the aforementioned system die 6 along a longitudinal direction (the system die 6 being therefore interposed between the respective monitoring dies 16 of the first and second transducer devices 15, 18).

FIG. 5 illustrates plots corresponding to the values of acoustic pressure, Pa, associated with the acoustic detection waves, in the absence (NoDelamination) or in the presence of a delamination 10 (which may only affect the top surface, DelaminationTOP, or both of the surfaces, DelaminationALL, of the system die 6).

The characteristics (for example in terms of amplitude and/or of a corresponding time trend, for example as regards the arrival time, so-called “time of flight”) of the detected signal (due to the acoustic detection waves reaching the second transducer device 18) are considerably different in the presence of defects at the interface between the system die 6 and the coating region 5 with respect to the case of absence of the same defects.

In particular, the amplitude of the detected signal is considerably lower, in the example illustrated about half, in the event that a defect is present, for example the aforementioned delamination 10 at the interface between the system die 6 and the coating region 5.

As a function of processing of the characteristics of the detected signal (for example through an analysis of amplitude or energy content within a given time window), the onset of defects within the package 2 of integrated system 1 may therefore be detected, in real time.

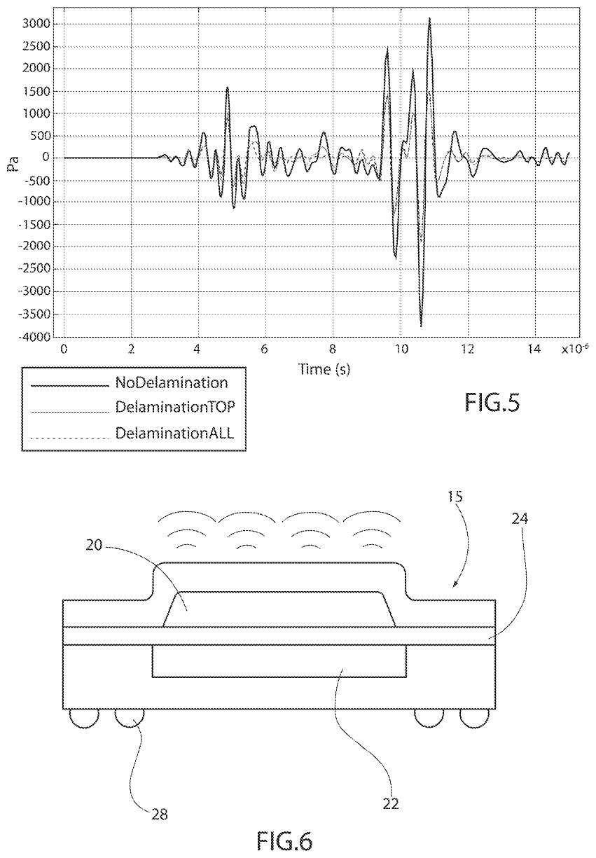

In greater detail, the aforementioned transducer device 15 may be made as shown schematically in FIG. 6, i.e., with a stacked arrangement of a corresponding matrix or array 20 of PMUT transducer elements, for emitting and/or receiving ultrasound waves, and of a corresponding ASIC circuit 22, coupled to the same matrix 20 (having the function of driving and/or processing of the detected signals, depending on the operation as ultrasound emitter and/or receiver). The aforementioned matrix 20 and the aforementioned ASIC circuit 22 may be coupled on opposite sides of a common substrate 24, having respective connection elements 28 at the bottom, in the example in the form of conductive balls, for the electrical coupling to the support base 4 (not illustrated here) of the package 2 of the integrated system 1.

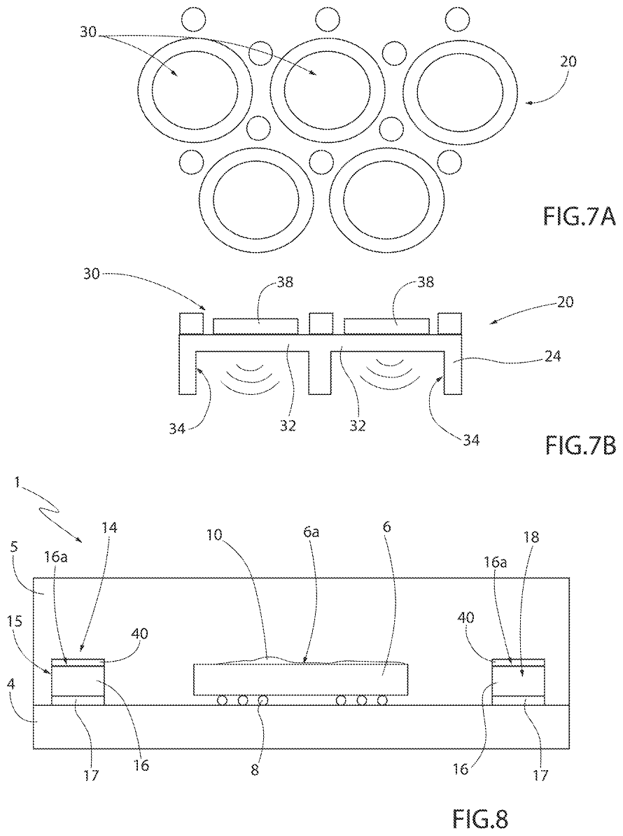

As shown schematically in FIGS. 7A and 7B, the aforementioned matrix 20 is made of a plurality of PMUT transducer elements 30, each comprising a respective membrane 32 suspended above a cavity 34 buried in a surface portion of the substrate 24 and a respective piezoelectric stack 38, formed (in a manner not illustrated in detail) by a bottom electrode, a piezoelectric material region and a top electrode (the piezoelectric material region being interposed between the bottom electrode and the top electrode).

In a manner not illustrated in detail, suitable electrical connection paths through the substrate 24 connect the aforementioned bottom electrode and top electrode to the respective ASIC circuit 22, which may comprise: a driving module, for supplying suitable biasing signals to the aforementioned bottom electrode and top electrode to cause the deformation of the membrane 32 and generation of acoustic detection waves (particularly in the ultrasound range, for example with a resonance frequency around 5 MHz); and/or a detection module, for reading the electrical signals transduced by the same bottom electrode and top electrode when the membrane 32 is deformed by impinging acoustic waves, for example due to the reception of the aforementioned acoustic detection waves.

A suitable matrix arrangement of the PMUT transducer elements 30 may allow a desired scan of the defects within the package 2, or in any case directing, in a desired manner, the generated acoustic detection waves towards the interfaces to be monitored between the system dies 6 and the coating region 5.

As shown schematically in FIG. 8, a further aspect of the present disclosure envisages the presence of an interface region 40 interposed between the top surface (indicated by 16a) of the monitoring die 16 of the first and second transducer devices 15, 18 (or only of the first transducer device 15, in case it operates as both emitter and receiver) and the coating region 5. In particular, this interface region 40 has, in this case, an acoustic impedance matching function.

With reference to the embodiment previously discussed, for example, this interface region 40 may be arranged between the matrix 20 of the PMUT transducer elements 30 (in particular, between the corresponding piezoelectric stacks 38) and the aforementioned coating region 5.

Depending on the material of the coating region 5, even significant reflections of the generated acoustic detection waves may in fact occur, due to an acoustic impedance mismatching between the transducer material (for example the piezoelectric material of the PMUT transducer elements 30) and the same coating region 5.

For example, the coating region 5, in the case of epoxy resin, may have a characteristic acoustic impedance Z₁ equal to 2.64·10⁶ Kg/m²·s, as compared to the acoustic impedance Z₂ of the piezoelectric material of the transducer equal to 3.25·10⁶ Kg/m²·s.

The thickness of the aforementioned interface region 40 is advantageously sized at ¼ wavelength and the corresponding characteristic impedance, Z₃, is calculated as: Z₃=\sqrt{Z₁·Z₂}, in the example being equal to 2.93·10⁶ Kg/m²·s.

In this example, the interface region 40 may comprise a hard silicone material, such as a silicone plastic, having a characteristic impedance of 2.73·10⁶ Kg/m²·s, which most closely approaches the aforementioned value of the impedance Z₃.

The advantages of the present disclosure are clear from the preceding description.

In any case, it is emphasized again that the monitoring system 14 allows detecting, advantageously in real time, the presence of defects, for example delaminations, within the package 2 of an integrated system 1.

The disclosure described is simple and inexpensive to implement, without entailing a substantial increase in manufacturing costs.

This disclosure is therefore particularly advantageous for implementing, for example, in an electronic apparatus, for example of the portable or wearable type (for example a smart bracelet or watch).

The electronic apparatus may comprise a main controller (a microcontroller, a microprocessor or a similar digital processing unit), which may be coupled to the monitoring system 14, in order to receive information corresponding to the detection of defects within the package 2.

This main controller, as a function the detection of the aforementioned defects, may perform suitable actions, for example emitting a warning signal associated with the presence of the same defects.

Finally, it is clear that modifications and variations may be made to what has been described and illustrated without thereby departing from the scope of the present disclosure, as defined in the attached claims.

In particular, it is underlined that the monitoring system 14 may comprise a plurality of transducer devices (indicated in general by 15) within the package 2, configured and arranged for monitoring the defects within the coating region 5, operating as a transmitter or receiver of acoustic detection waves.

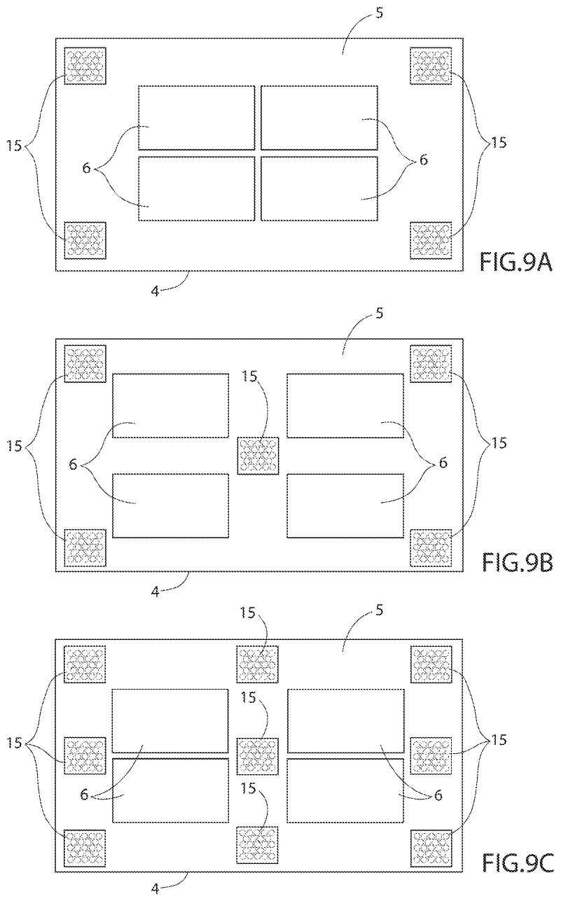

By way of example, FIGS. 9A-9C show possible variant embodiments, wherein the integrated system 1 comprises, by way of example, four system dies 6 (three dies integrating respective ASIC electronic circuits and one die integrating a MEMS sensor).

In particular, in FIG. 9A, the monitoring system 14 comprises four transducer devices 15, arranged in plan view at the vertices of the support base 4 of the package 2 (having a substantially rectangular shape in plan view); in this case, the aforementioned system dies 6 are arranged centrally with respect to the same support base 4, in a position close to each other.

In FIG. 9B, the monitoring system 14 comprises (in addition to the aforementioned four transducer devices 15) a further transducer device 15, arranged at the center of the aforementioned support base 4, surrounded by the system dies 6.

In FIG. 9C, the monitoring system 14 comprises nine transducer devices 15, arranged in rows of three, respectively at the external sides and at the center of the support base 4; in this case, the system dies 6 are arranged between respective rows of transducer devices 15.

However, it is clear that further and different arrangements of the transducer devices 15 may be provided and implemented, in order to obtain a desired redundancy of the monitoring information for detecting defects within the package 2 of the integrated system 1.

Furthermore, it is highlighted that, in an alternative embodiment, the transducer device(s) 15 may comprise a respective Capacitive Micromachined Ultrasonic Transducer, CMUT.

The driving and/or detection circuit associated with the transducer device 15 may alternatively be provided externally to the monitoring die 16 of the same transducer device 15, for example within the aforementioned main controller of the electronic apparatus wherein the integrated system 1 is used.

An integrated electronic system (1) provided with a package (2) formed by a support base (4) and by a coating region (5) arranged on the support base (4) and may be summarized as including at least a first system die (6), including semiconductor material, coupled to the support base (4) and arranged in the coating region (5), further including, within the package (2), a monitoring system (14) configured to determine the onset of defects within the coating region (5), through the emission of acoustic detection waves and the acquisition of corresponding received acoustic waves, whose characteristics are affected by, and therefore are indicative of, the aforementioned defects.

Said defects may include a delamination with partial or total detachment, from said coating region (5), of a top surface (6a) and/or of a bottom surface of said first system die (6), the bottom surface being coupled to the support base (4).

Said monitoring system (14) may include at least one transducer device (15) formed in a first monitoring die (16), coupled to the support base (4) within the coating region (5), said transducer device (15) being a micromachined ultrasound transducer, MUT.

Said transducer device (15) may be a piezoelectric transducer, PMUT—Piezoelectric Micromachined Ultrasound Transducer.

Said transducer device (15) may be a capacitive transducer, CMUT—Capacitive Micromachined Ultrasound Transducer.

Said transducer device (15) may be configured to emit ultrasound waves which propagate within the coating region (5), in a manner confined thereto, so as to reach said system die (6); and said monitoring system (14) may be configured to process signals detected as a function of received ultrasound waves, whose characteristics may be affected by the presence of said defects, so as to detect the presence of said defects in real time.

In the presence of said defects, characteristics in terms of amplitude and/or of a corresponding time trend of the detected signals may be different with respect to the case of absence of defects.

The system may include at least one further transducer device (18) designed to operate as a receiver of acoustic detection waves, formed in a second monitoring die (16), coupled to the support base (4) within the coating region (5); wherein said first system die (6) may be interposed between said first and second monitoring dies (16) along a direction of propagation of said acoustic detection waves within the coating region (5).

Said transducer device (15) may include a matrix (20) of PMUT transducer elements (30), configured for emitting and/or receiving ultrasound waves, and a corresponding ASIC circuit (22), coupled to the matrix (20) and integrated in said first monitoring die (16), having the function of driving and/or processing of the signals detected by said PMUT transducer elements (30).

Said matrix (20) and said ASIC circuit (22) may be coupled on opposite sides of a common substrate (24), having connection elements (28) at a bottom for the electrical coupling to the support base (4) of the package (2) of the integrated system (1).

The system may further include an interface region (40) interposed between a top surface (16a) of said first monitoring die (16), opposite to a bottom surface coupled to said support base (4), and said coating region (5); said interface region (40) having an acoustic impedance matching function.

A thickness of said interface region (40) may be sized at ¼ of a wavelength of said acoustic detection waves and a corresponding characteristic impedance, Z₃, may be calculated as: Z₃=\sqrt{Z₁·Z₂}, where Z₁ is a characteristic impedance of said coating region (5) and Z₂ is a characteristic impedance associated with said transducer device (15).

A method for monitoring the onset of defects for an integrated electronic system (1) provided with a package (2) formed by a support base (4) and by a coating region (5) arranged on the support base (4) and may be summarized as including at least one first system die (6), including semiconductor material, coupled to the support base (4) and arranged in the coating region (5), including determining the onset of defects within the coating region (5), through the emission of acoustic detection waves and the acquisition of corresponding received acoustic waves, whose characteristics are affected by, and therefore are indicative of, the aforementioned defects.

Said monitoring may be performed in real time.

Said defects may include a delamination with partial or total detachment from said coating region (5) of a top surface (6a) and/or of a bottom surface of said first system die (6), said bottom surface being coupled to the support base (4).

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a package including:
a support base;
a coating region on the support base;
at least a first system die coupled to the support base and in the coating region; and
a monitoring system in the coating region, the monitoring system configured to, in operation, determine an onset of defects within the coating region through an emission of acoustic detection waves and an acquisition of corresponding received acoustic waves, the acoustic detection waves characteristics are affected by the aforementioned defects.

2. The system according to claim 1, wherein the defects include a delamination with at least partial detachment from the coating region.

3. The system according to claim 1, wherein the monitoring system includes a first monitoring die having at least one first transducer device, the first monitoring die is coupled to the support base and is within the coating region, and the at least one first transducer device being a micromachined ultrasound transducer (MUT).

4. The system according to claim 3, wherein the at least one first transducer device is a piezoelectric transducer (PMUT—Piezoelectric Micromachined Ultrasound Transducer).

5. The system according to claim 3, wherein the at least one first transducer device is a capacitive transducer (CMUT—Capacitive Micromachined Ultrasound Transducer).

6. The system according to claim 3, wherein:
at least one first transducer device is configured to, in operation, emit the acoustic detection waves, which are ultrasound waves, the acoustic detection waves propagate within the coating region in a manner confined to the coating region and to reach the system die; and
the monitoring system is configured to, in operation, process signals detected as a function of the received acoustic waves, which are ultrasound waves to detect the presence of the defects.

7. The system according to claim 6, wherein the detection of the presence of the defects is in real time.

8. The system according to claim 6, wherein, in the presence of the defects, the characteristics of the acoustic detection waves in terms of at least one of the following of an amplitude and a corresponding time trend of the signals are different relative to when the defects are absent.

9. The system according to claim 3, wherein:
the monitoring system further includes a second monitoring die having at least one second transducer device configured to, in operation, receive the corresponding received acoustic waves, the second monitoring die is coupled to the support base and is within the coating region; and
the first system die is between the first monitoring die and second monitoring die along a direction of propagation of the acoustic detection waves propagated within the coating region.

10. The system according to claim 3, wherein the at least one first transducer device includes:
a matrix of PMUT transducer elements, configured to, in operation, perform at least one of the following of emit the acoustic detection waves and receive the corresponding received acoustic waves; and
a corresponding ASIC circuit coupled to the matrix and integrated in the first monitoring die, the corresponding ASIC circuit is configured to, in operation, perform at least one of the following of driving the signals and processing the signals.

11. The system according to claim 10, wherein the matrix and the ASIC circuit are coupled on opposite sides of a substrate, and the substrate having connection elements for electrically coupling the substrate to the support base.

12. The system according to claim 3, further comprising an interface region between a first surface of the first monitoring die and the coating region, the first surface of the first monitoring die is opposite to a second surface of the first monitoring die, and the second surface of the first monitoring die is coupled to the support base, and the interface region having an acoustic impedance matching function.

13. The system according to claim 12, wherein a thickness of the interface region is sized at ¼ of a wavelength of the acoustic detection waves and a corresponding characteristic impedance, Z₃, is calculated as: Z₃=\sqrt{Z₁·Z₂}, where Z₁ is a characteristic impedance of the coating region and Z₂ is a characteristic impedance associated with the at least one first transducer device.

14. A method, comprising:
monitoring the onset of defects for an integrated electronic system provided with a package including a support base, a coating region on the support base, and at least one first system die coupled to the support base and in the coating region, monitoring the onset of defects for the integrated electronic system includes:
determining the onset of defects within the coating region by emitting acoustic detection waves and acquiring corresponding received acoustic waves, characteristics of the acoustic detection waves are affected by the defects.

15. The method according to claim 13, wherein the monitoring is performed in real time.

16. The method according to claim 13, wherein the defects include at least one of the following of a delamination with at least partial detachment from the coating region.

17. A device, comprising:
a support base including a surface;
a monitoring system on the support base including one or more monitoring die coupled to the surface of the support base;
a die coupled to the surface of the support base; and
a coating region on and covering the support base, the monitoring system, and the die, and
wherein the monitoring system is configured to, in operation, detect an onset of defects within the coating region.

18. The device of claim 17, wherein the one or more monitoring die includes a first monitoring die configured to, in operation, emit an acoustic detection waves whose characteristics are affected by the defects.

19. The device of claim 18, wherein the one or more monitoring die includes a second monitoring die configured to, in operation, receive corresponding received acoustic waves.

20. The device of claim 19, further comprising:
a first interface region between a first surface of the first monitoring die facing away from the support base and the coating region; and
a second interface region between a second surface of the second monitoring die facing way from the support base and the coating region.
